(19) United States
(12) Patent Application Publication
(10) Pub. No.: US 2026/0135043 A1
(43) Pub. Date: May 14, 2026

(54) Center-perforated Annular Ceramic Capacitor

(71) Applicant: Shenzhen Ampron Technology Co., Ltd, Shenzhen (CN)

(72) Inventors: Junxin Luo, Shenzhen (CN); Wen Xu, Shenzhen (CN)

(21) Appl. No.: 19/245,395

(22) Filed: Jun. 22, 2025

(30) Foreign Application Priority Data
Nov. 14, 2024 (CN) 202411621262.X

(51) Int. Cl. H01G 5/40; G01L 9/00; H01G 5/013

(52) U.S. Cl. CPC H01G 5/40; G01L 9/0075; H01G 5/0138

(57) ABSTRACT

The present application discloses a center-perforated annular ceramic capacitor. An annular capacitor is formed by combining and sintering a ceramic base and a ceramic reaction diaphragm, and axes of the ceramic base and the ceramic reaction diaphragm are both provided with through holes to provide an assembly path for circuit elements to be combined, and a structure of the temperature-pressure sensor as a whole is simplified, including a circuit and a sealing structure, thereby enabling the temperature-pressure sensor to have a structure of automatic assembly and reducing the production and assembly costs; the first annular circuit and the second annular circuit of the annular capacitor design have a higher initial value and wider capacitance variation compared with the central non-through hole disc-shaped ceramic capacitor, so that the annular capacitor has a wider measuring range and finer pressure sensing classification, thereby improving accuracy of pressure measurement.

### CROSS REFERENCES TO RELATED APPLICATION

The present application claims the benefit of Chinese Patent Application No. 202411621262.X filed on Nov. 14, 2024, the contents of which are incorporated herein by reference in their entirety.

### TECHNICAL FIELD

The present application relates to the technical field of sensors and, in particular, to a center-perforated annular ceramic capacitor.

### BACKGROUND ART

The structure of the temperature-pressure sensor is: a temperature sensing portion, a pressure sensing portion and a control processing portion which are arranged in sequence in the axial direction; in order not to affect simultaneous detection of the pressure and the temperature, it is necessary to introduce the detected liquid into the reaction diaphragm of the pressure sensing portion so as to sense the pressure of the liquid through the minute deformation of the reaction diaphragm, but not to affect the detection of the temperature of the liquid by the temperature sensing portion, and separate the detection channels of the pressure and the temperature.

The existing ceramic capacitance of the pressure sensing portion is a closed circular ceramic capacitance pressure sensor, or a square ceramic capacitance pressure sensor, which allows the circuit of the temperature sensing portion to bypass the pressure sensing portion so as to connect the control processing portion located above, so that the structural complexity of the sensor increases.

The current processing methods are, for example, the present application patent: CN108414030B, in order not to increase the volume of the temperature-pressure sensor, and also to avoid affecting the performance of the ceramic capacitor, the eccentric capacitor is perforated at the periphery of the capacitor, and the lead of the temperature sensor portion is guided from the side to the control processing portion, because the guided lead is soft, and this design method makes the assembly and manufacture of the temperature-pressure sensor impossible to be achieved in an automatic assembly manner, and can only be assembled manually, so that the manufacturing cost thereof is relatively high, and the production efficiency thereof is also relatively low compared with that of the automatic assembly; at the same time, the quality stability of the finished products assembled manually is not as high as that of the automatic assembly, so there is an urgent need for a temperature-pressure sensor structure which can facilitate the automatic assembly and can also improve the pressure measurement performance to a certain extent.

However, the optimal processing solution is to make holes in the center of the ceramic capacitor so that the lead of the temperature sensor can pass directly from the center of the ceramic capacitor to the control processing portion without winding on the side, which makes the structure of the temperature-pressure sensor simple and automatic assembly possible. However, with the current structure of ceramic capacitor, it is impossible to perforate the hole in the center of ceramic capacitor, which will affect the pressure sensing performance of the ceramic capacitor.

In summary, it has been found that the prior art has at least the following technical problems:
the existing ceramic capacitor configurations fail to achieve the automatic assembly problem of the temperature-pressure sensor.

### SUMMARY OF THE INVENTION

It is an objective of the present application to provide a center-perforated annular ceramic capacitor which solves the problem that the structure of the existing ceramic capacitor cannot achieve the automatic assembly of the temperature-pressure sensor without affecting the pressure sensing performance of the ceramic capacitor in the temperature-pressure sensor.

The technical effects of the preferred embodiments of the present application are described in detail in the following.

In order to solve the above-mentioned technical problem, the present application provides the following technical solutions:
the present application provides a center-perforated annular ceramic capacitor including a ceramic base and a ceramic reaction diaphragm, where axes of the ceramic base and ceramic reaction diaphragm are respectively provided with a through hole for providing an assembly path for circuit elements to be combined; a first annular circuit is printed on one face of the ceramic base; the first annular circuit surrounds the through hole, a first insulation region is provided between an inner hole of the first annular circuit and the through hole, and a second insulation region is provided between an outer ring of the first annular circuit and an outer edge of the ceramic base; the other face of the ceramic base is provided with a plurality of pins, and the plurality of pins are perforated to the face provided with the first annular circuit; a lead wire of the first annular circuit is arranged in the second insulation region and is electrically connected to the pin; a second annular circuit is printed on one face of the ceramic reaction diaphragm; the ceramic reaction diaphragm is merged with the ceramic base by means of facing the second annular circuit towards the first annular circuit of the ceramic base, and a lead wire of the second annular circuit of the ceramic reaction diaphragm is electrically connected to one of the pins of the ceramic base; the other face of the ceramic reaction diaphragm is used for receiving impact of a medium to be measured to obtain pressure-generated deformation; and an insulating layer is coated on a surface of the first annular circuit; the first insulation region and the second insulation region are coated with an insulation glue; the insulating layer and the insulation glue are used for separating the ceramic reaction diaphragm from the ceramic base; the ceramic reaction diaphragm is combined with the ceramic base and then sintered to form an annular capacitor; and capacitance of the annular capacitor is from 10 to 80 pf.

In one embodiment, the diameter of the through hole is not more than 3.5 mm.

In one embodiment, a coincidence error between an axis of the through hole and the axis of the ceramic base and the axis of the ceramic reaction diaphragm is not more than 3 mm.

In one embodiment, the ceramic reaction diaphragm has a thickness of from 0.2 to 1.2 mm.

In one embodiment, a variation of the annular capacitor after the ceramic reaction diaphragm is pressed is from 1 to 30 pf.

In one embodiment, a material for the insulation glue contains 60-80% of glass powder.

In one embodiment, a material for the insulating layer contains 70-90% of glass powder.

In one embodiment, a printed material of the first annular circuit and the second annular circuit is gold.

In one embodiment, the first annular circuit is composed of two annular electrodes including a first annular electrode and a second annular electrode; the second annular electrode surrounds the first annular electrode, and the first annular electrode is adjacent to the first insulation region; and the first annular electrode is spaced apart from the second annular electrode.

In one embodiment, the second annular circuit is composed of one annular electrode, which is a third annular electrode; the third annular electrode overlies the first annular electrode and the second annular electrode.

Advantageous effects of the present application are as follows:
the center-perforated annular ceramic capacitor of the present application provides an improvement over disc-shaped ceramic capacitors in the prior art: 1. through holes are designed in the axis of the ceramic base and the ceramic reaction diaphragm, so that when the center-perforated annular ceramic capacitor is used in an integrated sensor such as a temperature-pressure sensor, a temperature probe which needs to be installed before the center-perforated annular ceramic capacitor is provided with an assembly channel through which the lead of the temperature probe can pass, so that the center-perforated annular ceramic capacitor can be more conveniently integrated into a complicated circuit of the original temperature-pressure sensor, which simplifies inclusion of the circuit and sealing structure in the structure of the temperature-pressure sensor, and also promotes the circuit assembly efficiency of the center-perforated annular ceramic capacitor, the temperature probe and the control processing portion, achieves the simplification of the assembly process, and also achieves the automatic assembly, and directly further improves the assembly efficiency and reduces more assembly costs.

2. The shape of the pressed face of the central non-through hole disc-shaped ceramic capacitor is circular. Compared with the circular pressed face, an axial stress of the circular pressed face is larger. In the deformation due to press, the distance from the center to the circumference of the circular pressed face is longer, and the moment arm is longer. The deformation of the center range of the circular pressed face is larger than that of the circumference edge. After repeated high-strength pressure impact, the reaction diaphragm is easy to fatigue, which accelerates the aging cracking.

In addition, the ceramic base and the ceramic reaction diaphragm of the center-perforated annular ceramic capacitor are both of an annular structure, and the electrode printed on the surface thereof is also of an annular structure; when pressed, the shape of the pressed face of the ceramic reaction diaphragm is annular, and the initial value of the annular capacitor is designed to be larger. Only a small change in the shape of the pressed ceramic reaction diaphragm can cause a larger change in the capacitance value of the annular capacitor, and the deformation of the ceramic reaction diaphragm is smaller, so that the service life of the diaphragm is improved, and the pressure sensor equipped with the center-perforated annular ceramic capacitor has better stability and reliability.

3. The center-perforated annular ceramic capacitor has a higher initial capacitance value and capacitance variation than the central non-through hole disc-shaped ceramic capacitor, so that the center-perforated annular ceramic capacitor has a wider measuring range and a thinner measuring scale, which means that a larger range of pressure can be detected and a finer pressure detection stage can be obtained, thereby making the pressure measurement accuracy of the temperature-pressure sensor equipped with the center-perforated annular ceramic capacitor higher.

### BRIEF DESCRIPTION OF THE DRAWINGS

To provide a clearer illustration of the technical solutions of the present application, the accompanying drawings required for the embodiments will be briefly described below. Obviously, the drawings in the following description are merely some embodiments of the present application. For a person skilled in the art, other drawings may be derived from these accompanying drawings without creative effort.

FIG. 1 is an axonometric structure diagram of an annular capacitor according to the present application;

FIG. 2 is a bottom view structure diagram of a ceramic base according to the present application;

FIG. 3 is a top view structure diagram of a ceramic reaction diaphragm according to the present application; and

FIG. 4 is a cross-sectional view structure diagram of an annular capacitor according to the present application.

The reference numerals are as follows:
1. ceramic base; 11. first annular circuit; 111. first annular electrode; 112. second annular electrode; 12. first insulation region; 13. second insulation region; 14. pin; 15. insulating layer; 16. insulation glue;
2. ceramic reaction diaphragm; 21. second annular circuit; 211. third annular electrode;
3. through hole;
4. lead wire.

### DETAILED DESCRIPTION OF THE INVENTION

The technical solutions in the embodiments of the present application will be described clearly and completely below in conjunction with the accompanying drawings in the embodiments of the present application.

In the detailed description, provided is a center-perforated annular ceramic capacitor formed by combining and sintering a ceramic base and a ceramic reaction diaphragm, and axes of the ceramic base and the ceramic reaction diaphragm are both provided with through holes to provide an assembly path for circuit elements to be combined, so that the annular capacitor is more conveniently integrated into a complex circuit of a temperature-pressure sensor, and a structure of the temperature-pressure sensor as a whole is simplified, including a circuit and a sealing structure, thereby enabling the temperature-pressure sensor to have a structure of automatic assembly and reducing the production and assembly costs. The first annular circuit and the second annular circuit of the annular capacitor design have a higher initial value and wider capacitance variation compared with the central non-through hole disc-shaped ceramic capacitor, so that the annular capacitor has a wider measuring range and finer pressure sensing classification, thereby improving accuracy of pressure measurement.

It should be noted that all configurations shown in the following embodiments are not limited to being essential to the solutions of the present application as claimed.

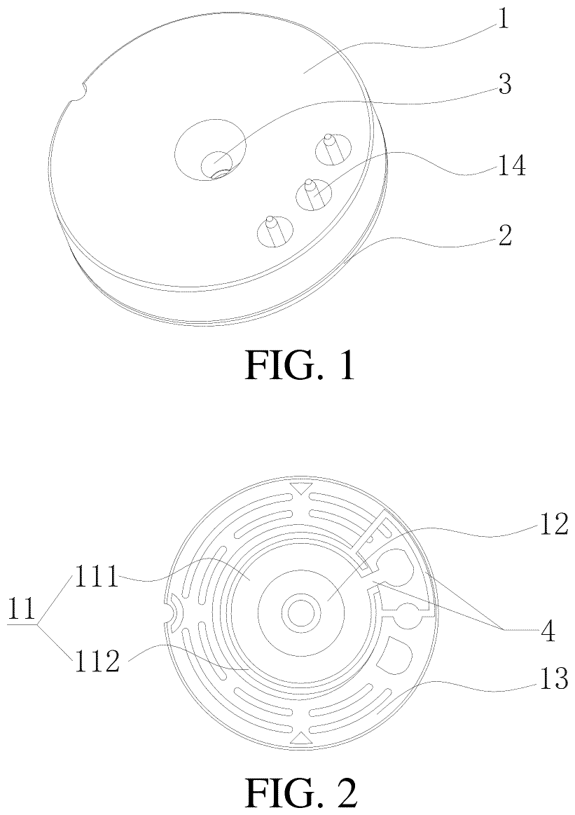

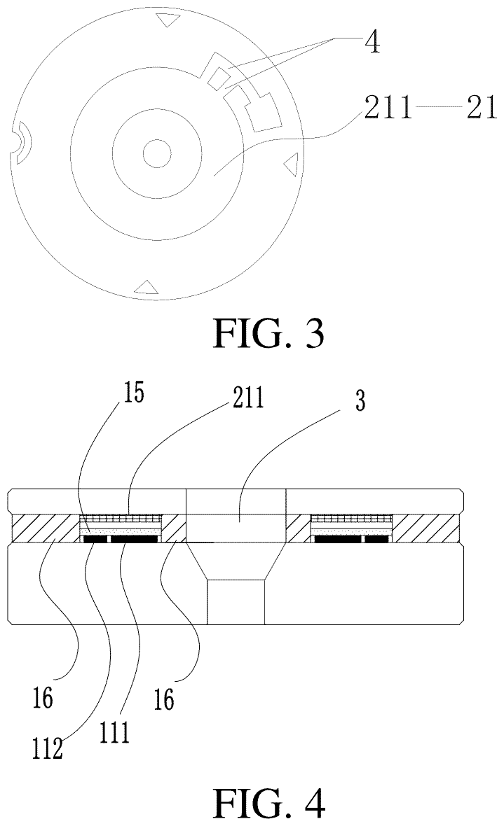

A first embodiment of a center-perforated annular ceramic capacitor is shown in FIGS. 1-4, and includes a ceramic base 1 and a ceramic reaction diaphragm 2, where axes of the ceramic base 1 and the ceramic reaction diaphragm 2 are respectively provided with a through hole 3 for providing an assembly path for circuit elements to be combined; a first annular circuit 11 is printed on one face of the ceramic base 1; the first annular circuit 11 surrounds the through hole 3, a first insulation region 12 is provided between an inner hole of the first annular circuit 11 and the through hole 3, and a second insulation region 13 is provided between an outer ring of the first annular circuit 11 and an outer edge of the ceramic base 1; the other face of the ceramic base 1 is provided with a plurality of pins 14, and the plurality of pins 14 are perforated to the face provided with the first annular circuit 11; a lead wire of the first annular circuit 11 is arranged in the second insulation region 13 and is electrically connected to the pin 14; a second annular circuit 21 is printed on one face of the ceramic reaction diaphragm 2; the ceramic reaction diaphragm 2 is merged with the ceramic base 1 by means of facing the second annular circuit 21 towards the first annular circuit 11 of the ceramic base, and a lead wire of the second annular circuit 21 of the ceramic reaction diaphragm 2 is electrically connected to one of the pins 14 of the ceramic base 1; the other face of the ceramic reaction diaphragm 2 is used for receiving impact of a medium to be measured to obtain pressure-generated deformation; and an insulating layer 15 is coated on a surface of the first annular circuit 11; the first insulation region 12 and the second insulation region 13 are coated with an insulation glue 16; the insulating layer 15 and the insulation glue 16 are used for separating the ceramic reaction diaphragm 2 from the ceramic base 1; the ceramic reaction diaphragm 2 is combined with the ceramic base 1 and then sintered to form an annular capacitor.

The medium to be measured received on the other side of the ceramic reaction diaphragm 2 may be a gas or a liquid or the like capable of giving a pressure.

The first annular circuit 11 is composed of two annular electrodes including a first annular electrode 111 and a second annular electrode 112; the second annular electrode 112 surrounds the first annular electrode 111, and the first annular electrode 111 is adjacent to the first insulation region 12; and the first annular electrode 111 is spaced apart from the second annular electrode 112.

The second annular circuit 21 is composed of an annular electrode, which is a third annular electrode 211; the third annular electrode 211 covers the first annular electrode 111 and the second annular electrode 112;

Specifically, the first annular electrode 111, the second annular electrode 112 and the third annular electrode 211 are respectively provided with a lead wire 4;

The second annular electrode 112 is provided with a notch, a lead wire of the first annular electrode 111 extends out from the notch and is electrically connected to the first pin 14, and two ends of the notch of the second annular electrode 112 extend out from the lead wire and are electrically connected to the second pin 14. The lead wire of the third annular electrode 211 is electrically connected to the third pin 14.

Further, the area of the first annular electrode 111 is larger than that of the second annular electrode 12.

Specifically, the peripheries of the ceramic base 1 and the ceramic reaction diaphragm 2 are circular. Therefore, the annular capacitor formed by the ceramic reaction diaphragm 2 and the ceramic base 1, and the electrodes on the ceramic reaction diaphragm 2 and the ceramic base 1 are not only annular, but also the ceramic reaction diaphragm 2 and the ceramic base 1 are circular, and a central perforation is superimposed; and the ceramic reaction diaphragm 2 and the ceramic base 1 merge to form an annular capacitor.

Further, the shape of the pressed face of the central non-through hole disc-shaped ceramic capacitor is annular. Compared with the circular pressed face, an axial stress of the circular pressed face is larger. In the deformation due to press, the distance from the center to the circumference of the circular pressed face is longer, and the moment arm is longer. The deformation of the center range of the circular pressed face is larger than that of the circumference edge. After repeated high-strength pressure impact, the reaction diaphragm is easy to fatigue, which accelerates the aging cracking.

In addition, the ceramic base 1 and the ceramic reaction diaphragm 2 of the center-perforated annular ceramic capacitor are both of an annular structure, and the electrode printed on the surface thereof is also of an annular structure; when pressed, the shape of the pressed face of the ceramic reaction diaphragm 2 is annular, and the initial value of the annular capacitor is designed to be larger. Only a small change in the shape of the pressed ceramic reaction diaphragm 2 can cause a larger change in the capacitance value of the annular capacitor, and the deformation of the ceramic reaction diaphragm 2 is smaller, so that the service life of the diaphragm is improved, and the pressure sensor equipped with the center-perforated annular ceramic capacitor has better stability and reliability.

Further, for the center-perforated annular ceramic capacitor, through holes 3 are designed in the axis of the ceramic base 1 and the ceramic reaction diaphragm 2, so that when the center-perforated annular ceramic capacitor is used in an integrated sensor such as a temperature-pressure sensor, a temperature probe which needs to be installed before the center-perforated annular ceramic capacitor is provided with an assembly channel through which the lead of the temperature probe can pass, so that the center-perforated annular ceramic capacitor can be more conveniently integrated into a complicated circuit of the original temperature-pressure sensor, which simplifies inclusion of the circuit and sealing structure in the structure of the temperature-pressure sensor, and also promotes the circuit assembly efficiency of the center-perforated annular ceramic capacitor, the temperature probe and the control processing portion, achieves the simplification of the assembly process, and also achieves the automatic assembly, and directly further improves the assembly efficiency and reduces more assembly costs.

(1) By using the temperature-pressure sensor of the center-perforated annular ceramic capacitor, compared with the former generation of the disc-shaped ceramic capacitor using the central non-through hole, that is, the patent: CN108414030B, parts on the sealing structure are reduced by one base and two sealing rings, assembled parts are reduced, material cost is reduced, assembling process is reduced, and assembling cost is also reduced.

(2) In the circuit structure, the former generation temperature-pressure sensor temperature probe is used as a flexible flat cable, so that a lead of the temperature probe at the axis of the temperature-pressure sensor needs to be wound from the axis to a flattened notch of the circumference side of the disc-shaped ceramic capacitor during the installation, and the lead passes through the notch to reach a circuit board of the control processing portion to perform the welding of the circuit. Since the temperature probe is used as the flexible flat cable, the assembly of this generation temperature-pressure sensor product can only be completed manually, and the welding of the flat cable can also only be completed manually, which results in that the automation of the assembly cannot be achieved, the assembly process increases, the assembly efficiency decreases, and the assembly cost rises linearly; in addition, when the center-perforated annular ceramic capacitor is applied, the lead of the temperature probe of the temperature-pressure sensor can be changed in use as a pin, so that when the temperature probe is automatically assembled, after being automatically clamped, the pin directly passes through the through hole 3 in the center of the center-perforated annular ceramic capacitor, and reaches the corresponding pin hole of the control processing portion; then the pins of the center-perforated annular ceramic capacitor are aligned with the corresponding pin holes of the control processing portion, and the temperature probe and the pins of the center-perforated annular ceramic capacitor are directly welded with the circuit board of the control processing portion by means of automatic welding, so that the assembly process is simplified, and the automatic welding of the temperature probe and the center-perforated annular ceramic capacitor is achieved, which directly improves the assembly efficiency and reduces the assembly cost.

As one of the alternative embodiments,
for the diameter of the through hole 3 in the center of the above-mentioned ceramic base 1 and ceramic reaction diaphragm 2, the diameter of the through hole 3 is not more than 3.5 mm.

In addition, a coincidence error between an axis of the through hole 3 and the axis of the ceramic base 1 and the axis of the ceramic reaction diaphragm 2 is not more than 3 mm.

For the thickness of the ceramic reaction diaphragm 2 described above, the thickness of the ceramic reaction diaphragm 2 is in a range of from 0.2 to 1.2 mm.

In the application, the thinnest ceramic reaction diaphragm 2 with a central hole can be manufactured to 0.2 mm, so that the overall thickness of the annular capacitor is smaller, so that the overall height of the temperature-pressure sensor equipped with the annular capacitor is further reduced, the volume of the sensor is reduced, and the integration degree is further improved; a smaller temperature-pressure sensor means that the volume requirements of the installation scenario can be higher, the application barrier of the temperature-pressure sensor is smaller, and the application range is wider.

In addition, the thinner ceramic reaction diaphragm 2 makes the annular capacitor have a higher sensitivity, can detect a liquid with a smaller pressure change, the pressure detection is more precise, the application range is further improved, and can be used in a micro-pressure scene.

Further, for the capacitance variation of the above-mentioned annular capacitor, the capacitance variation of the annular capacitor after the ceramic reaction diaphragm 2 is pressed is from 1 to 30 pf.

The capacitance of the above-mentioned annular capacitor is from 10 to 80 pf; that is to say, the initial capacitance value of the annular capacitor is from 10 to 80 pf at the time of measuring the voltage, and the range of the initial capacitance value is wider.

Comparative test results: Y1 is an annular capacitor according to the present application, and Y2 is a central non-through hole disc-shaped ceramic capacitor;

Capacitance
shape;

| thickness of | Initial | Pressurized 0.5 mpa | | Pressurized 1 mpa | |
|---|---|---|---|---|---|
| the reaction | capacitance | Capaci- | Vari- | Capaci- | Vari- |
| diaphragm; | value; | tance | ation | tance | ation; |
| Y1; 0.2; | 61.65 pf | 64.34 pf | 2.69 pf | 67.88 pf | 6.23 pf |
| Y1; 0.5; | 38.61 pf | 39.96 pf | 1.35 pf | 40.56 pf | 1.95 pf |
| Y1; 0.6; | 21.81 pf | 22.83 pf | 1.02 pf | 23.32 pf | 1.51 pf |
| Y2; 0.2; | / | / | | / | |
| Y2; 0.5; | 25.63 pf | 28.38 pf | 2.75 pf | 29.92 pf | 4.29 pf |
| Y2; 0.6; | 23.36 pf | 24.91 pf | 1.55 pf | 27.37 pf | 4.01 pf |

In the application, it can be concluded from the comparative test data that the center-perforated annular ceramic capacitor has a higher initial capacitance value and wider capacitance variation than the central non-through hole disc-shaped ceramic capacitor, so that the center-perforated annular ceramic capacitor has a wider measuring range and a thinner measuring scale, which means that a larger range of pressure can be detected and a finer pressure detection stage can be obtained, thereby making the pressure measurement accuracy of the temperature-pressure sensor equipped with the center-perforated annular ceramic capacitor higher.

For the above-mentioned key components of the insulation glue 16 covering the first insulation region 12 and the second insulation region 13, the material of the insulation glue 16 contains 60-80% of glass powder.

For the above-mentioned key components of the transparent insulation layer 15 covering the first annular circuit 11, the material of the insulating layer 15 contains 70-90% of glass powder.

For the key components of the above-described first and second annular circuits 11 and 21, the printed material of the first and second annular circuits 11 and 21 is gold.

In the application, the glass powder will form an insulating layer after sintering, and the content of the glass powder will determine the insulation performance and insulation degree of the insulating layer, and different insulation properties are required in different regions so as to optimize the capacitance and capacitance variation of the annular capacitor to the greatest extent.

Each technical feature of the above-mentioned embodiments can be combined in any combination, and in order to make the description concise, not all the possible combinations of each technical feature in the above-mentioned embodiments are described.

1. A center-perforated annular ceramic capacitor, comprising a ceramic base and a ceramic reaction diaphragm, wherein
axes of the ceramic base and ceramic reaction diaphragm are respectively provided with a through hole for providing an assembly path for circuit elements to be combined;
a first annular circuit is printed on one face of the ceramic base; the first annular circuit surrounds the through hole, a first insulation region is provided between an inner hole of the first annular circuit and the through hole, and a second insulation region is provided between an outer ring of the first annular circuit and an outer edge of the ceramic base;
the other face of the ceramic base is provided with a plurality of pins, and the plurality of pins are perforated to the face provided with the first annular circuit; a lead wire of the first annular circuit is arranged in the second insulation region and is electrically connected to the pin;
a second annular circuit is printed on one face of the ceramic reaction diaphragm; the ceramic reaction diaphragm is merged with the ceramic base by means of facing the second annular circuit towards the first annular circuit of the ceramic base, and a lead wire of the second annular circuit of the ceramic reaction diaphragm is electrically connected to one of the pins of the ceramic base;
the other face of the ceramic reaction diaphragm is provided for receiving impact of a medium to be measured to obtain pressure-generated deformation; and
an insulating layer is coated on a surface of the first annular circuit; the first insulation region and the second insulation region are coated with an insulation glue; the insulating layer and the insulation glue are provided for separating the ceramic reaction diaphragm from the ceramic base; the ceramic reaction diaphragm is combined with the ceramic base and then sintered to form an annular capacitor; and capacitance of the annular capacitor is from 10 to 80 pf.

2. The center-perforated annular ceramic capacitor according to claim 1, wherein
the diameter of the through hole is not more than 3.5 mm.

3. The center-perforated annular ceramic capacitor according to claim 1, wherein
a coincidence error between an axis of the through hole and the axis of the ceramic base and the axis of the ceramic reaction diaphragm is not more than 3 mm.

4. The center-perforated annular ceramic capacitor according to claim 1, wherein
the ceramic reaction diaphragm has a thickness of from 0.2 to 1.2 mm.

5. The center-perforated annular ceramic capacitor according to claim 1, wherein
a variation of the annular capacitor after the ceramic reaction diaphragm is pressed is from 1 to 30 pf.

6. The center-perforated annular ceramic capacitor according to claim 1, wherein
a material for the insulation glue contains 60-80% of glass powder.

7. The center-perforated annular ceramic capacitor according to claim 1, wherein
a material for the insulating layer contains 70-90% of glass powder.

8. The center-perforated annular ceramic capacitor according to claim 1, wherein
a printed material of the first annular circuit and the second annular circuit is gold.

9. The center-perforated annular ceramic capacitor according to claim 1, wherein
the first annular circuit is composed of two annular electrodes including a first annular electrode and a second annular electrode; the second annular electrode surrounds the first annular electrode, and the first annular electrode is adjacent to the first insulation region; and the first annular electrode is spaced apart from the second annular electrode.

10. The center-perforated annular ceramic capacitor according to claim 9, wherein
the second annular circuit is composed of one annular electrode, which is a third annular electrode;
the third annular electrode overlies the first annular electrode and the second annular electrode.
